(19) United States
(12) Patent Application Publication
(10) Pub. No.: US 2005/0209911 A1
(43) Pub. Date: Sep. 22, 2005

(54) Identifying mobile service improvements and measuring their effectiveness

(76) Inventors: Anne Marie Burris, San Jose, CA (US); Gerald Winsor, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/805,466

(22) Filed: Mar. 19, 2004

(51) Int. Cl. G06F 17/60

(52) U.S. Cl. 705/11

(57) ABSTRACT

Methods and systems of identifying and measuring the effectiveness of mobile services and their GTM (go-to-market), process, and technology links are described. A mobile service provider identifies a business goal. A mobile service, processes and technology intended to achieve that goal are identified. Processes and technology are evaluated against a continuum to identify gaps for successful service launch. Metrics for measuring the effect of implementing the mobile service are established based on the above. After the mobile service provider implements the mobile service, input information that measures the effect of implementing the mobile service is compared against an expected value of the metric. The mobile service, processes and infrastructure can be reviewed and adjusted if the comparison indicates the expected value is not satisfied.

### TECHNICAL FIELD

Embodiments of the present invention relate to methods of identifying and implementing mobile services offered by mobile service providers.

### BACKGROUND ART

Wireless connectivity is rapidly becoming an integral part of society. In order to capture market share, wireless equipment providers and service providers must create an infrastructure enabling high quality voice and data services to be delivered when, where, and how they are needed by subscribers. The wireless/mobile market is still highly emerging with little in the way of broadly accepted standards available for technology, service descriptions, process, pricing, GTM (go-to-market), etc. Mobile providers are constantly monitoring the market to determine the next service that will be in high demand.

The telecommunications industry is unique in that services offered to the market by mobile operators are still dictated, in a large part, by device functionality and availability. Therefore, device providers and mobile operators are currently dictating what services are available and educating potential users. However, the expectation is that mobile subscribers will reinvent use processes and adopt services in ways not currently envisioned by the device providers and operators. At that point, mobile subscribers will put increased pressure on mobile operators and device providers, creating market pull, by defining what services they want. Currently, market leaders in this area are creating rather basic services that are differentiated by content and combination as needed. Mobile providers are under pressure to offer more differentiated services to maintain/increase revenue streams, while keeping capital expenses and operational expenses under control. The best way to do this is to shift development costs, as much as possible, to third-party service developers in a secure way.

As mobile service providers rely more on third-party developers, new challenges emerge:
how can the service provider network be opened securely to outside developers;
how can the service development administration be automated;
how can a third-party ecosystem be developed and managed;
how can higher volumes of services be incorporated into back-end billing and customer care systems efficiently;
how can the higher volumes of new services be efficiently provisioned;
how can higher volumes of services be monitored for profitability;
how are other providers approaching the highly volatile mobile market;
how do the other providers price services and go-to-market; and
how can capital investment in underlying technology be protected in a highly emerging market where market share is linked so closely to new technological developments.

Accordingly, a structured approach that can help mobile service providers understand their market and make decisions benefiting their business would be of value. Embodiments of the present invention provide these and other advantages.

### DISCLOSURE OF THE INVENTION

Embodiments of the present invention pertain to methods and systems of identifying and measuring the effectiveness of mobile service improvements and their GTM (go-to-market), process, and technology links. A mobile service provider identifies a business goal. A mobile service, processes and technology intended to achieve that goal are identified. Processes and technology are evaluated against a continuum to identify gaps for successful service launch. Metrics for measuring the effect of implementing the mobile service are established based on the above. After the mobile service provider implements the mobile service, input information that measures the effect of implementing the mobile service is compared against an expected value of the metric. The mobile service, processes and infrastructure can be reviewed and adjusted if the comparison indicates the expected value is not satisfied.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a flowchart of a phased approach for providing guidance to a mobile service provider in accordance with one embodiment of the present invention.

FIG. 2 is a flowchart of a method for identifying mobile services, go-to-market (GTM), process and technology approaches available to the operator according to one embodiment of the present invention.

FIG. 3A is a flowchart showing one method of identifying external results based on mobile services and measuring their effectiveness according to one embodiment of the present invention.

FIG. 3B is a flowchart showing one method of identifying internal return on investment based on suggested process and/or architecture roadmaps according to one embodiment of the present invention.

FIG. 4 is a flowchart of a process for implementing a mobile service in accordance with one embodiment of the present invention.

FIG. 5 illustrates an example of a service and technology matrix that can be used to identify mobile services and/or technology architecture according to one embodiment of the present invention.

FIG. 6 illustrates an example of a framework for identifying internal and external drivers that can influence a mobile service provider in accordance with one embodiment of the present invention.

### BEST MODE FOR CARRYING OUT THE INVENTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

Aspects of the present invention may be practiced on a computer system that includes, in general, a processor for processing information and instructions, random access (volatile) memory (RAM) for storing information and instructions, read-only (non-volatile) memory (ROM) for storing static information and instructions, a data storage device such as a magnetic or optical disk and disk drive for storing information and instructions, an optional user output device such as a display device (e.g., a monitor) for displaying information to the computer user, an optional user input device including alphanumeric and function keys (e.g., a keyboard) for communicating information and command selections to the processor, and an optional user input device such as a cursor control device (e.g., a mouse) for communicating user input information and command selections to the processor.

In overview, embodiments in accordance with the present invention assist mobile service providers in identifying and implementing new mobile services that are of benefit to them from a business perspective. Accordingly, service providers are better able to identify and provide services and features that satisfy their subscribers and attract new ones. This means providing sustainable value which cuts churn and makes for a more stable customer base. In general, this is accomplished using a phased approach to guide a mobile service provider through business, technical and process changes. In the first phase, mobile services that may be attractive to the mobile service provider are systematically identified. Once the business perspective is clear, it is possible to determine the process and technology architecture, ensuring the best return on their information technology investment. In the second phase, the mobile service provider is provided with assistance to update any business processes used in creating, launching, supporting, and killing a service; for example, how to change those processes to operate more efficiently, and how to manage the change. In the third phase, actual returns on investments are determined and compared against expected returns, and adjustments are made if the actual returns are less than expected.

Embodiments of the present invention pertain to structured methods for:
providing market perspective by acting as an extension to the operator's market intelligence unit;
identifying new mobile services, how they can be priced, and best go-to-market practices;
enhancing operator technology roadmaps;
defining operator process trees and choke-points;
providing process best practices, process implementation, and change management to ensure the best return on information technology (IT) capital investment, both for the operator and their enterprise end-customer; and
measuring the effectiveness of the above, both internally to the operator and externally, with the operator's customer.

Phase I Environmental Factors: In one embodiment, an environmental context associated with a mobile service provider is defined. The environmental context includes factors driving the mobile service provider, and may also include the relationships between the mobile service provider and those involved in their service creation and delivery value chain. One or more case studies relevant to the mobile service provider and the mobile service are evaluated and presented as contextual examples.

Phases I and 11 Contextual Analysis Based on a Continuum: The mobile service provider identifies a business goal. A mobile service intended to achieve that goal is identified. Gap(s) between the current state of the mobile service provider and the desired state needed to create and deliver the service(s) are identified. The group then discusses ways to fill identified gap(s). Although Phase I is focused on the operator's business direction, Phase II reviews aspects of the operator's operational process and technology roadmap. The goal of this analysis is to ensure the operator has the correct infrastructure to implement their chosen business direction.

Phases I and 11 Best Practice Identification: Best practices associated with implementing mobile services are identified. For each mobile service, the mobile service provider is placed at a point in a continuum ranging from not implementing the mobile service to implementing the mobile service according to a respective best practice. Current state gaps are identified and analyzed. Recommendations to fill the gaps are made.

Phase III Investment Value—Internal/External: One or more externally focused metrics measuring the mobile service business value are established. After the mobile service provider implements the mobile service, input information that measures the effect of implementing the mobile service is compared against an expected value of the metric. The mobile service can be reviewed and adjusted if the comparison indicates the expected value is not satisfied. An inwardly focused metric(s) measures the return on IT investment for the recommended IT infrastructure and the actual returns are compared against expected returns. The architecture can be reviewed and adjusted if the comparison indicates the expected value is not satisfied.

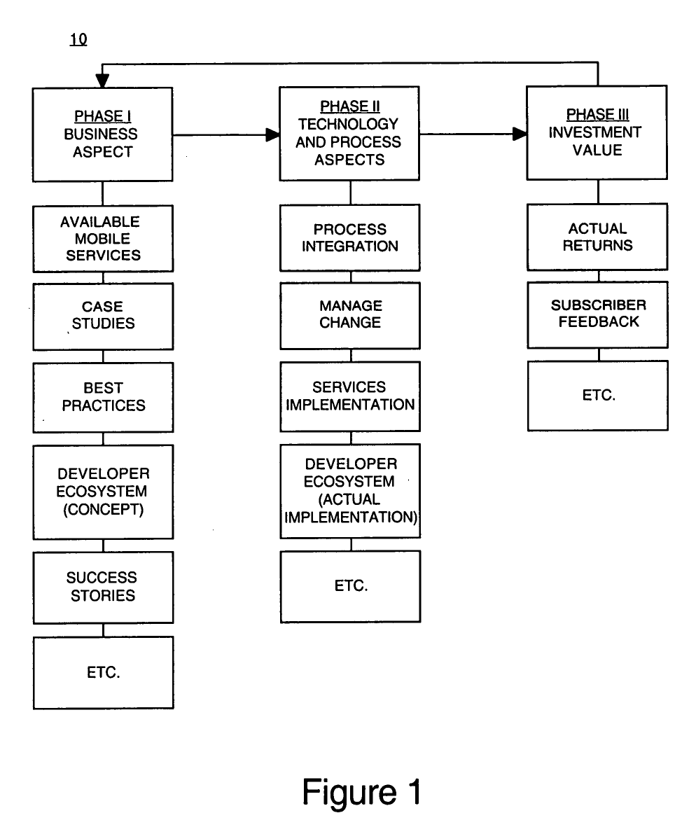

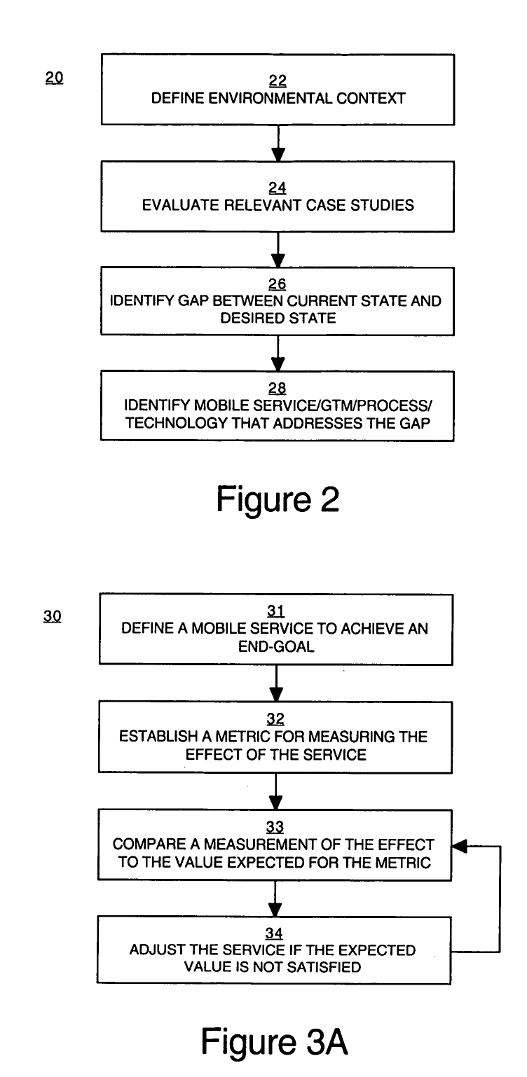

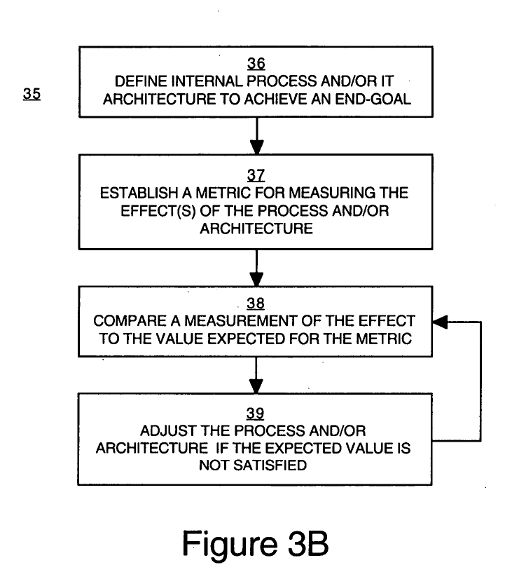

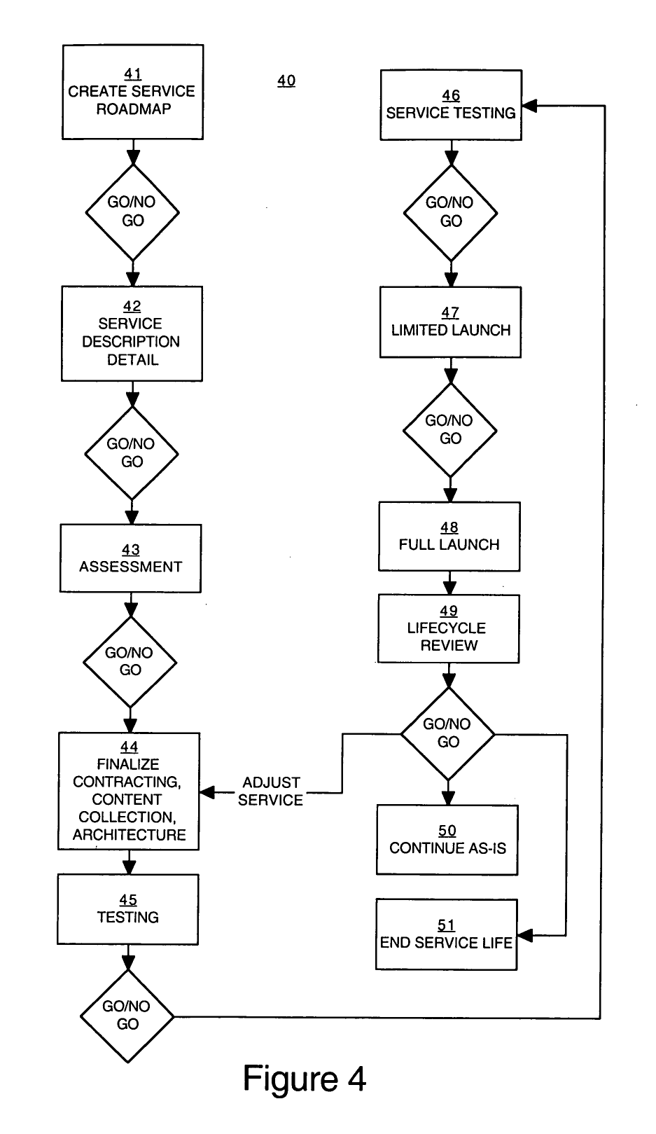

FIG. 1 is a flowchart 10 of a phased approach for providing guidance to mobile service providers in accordance with one embodiment of the present invention. FIG. 2 is a flowchart 20 of a method for identifying new mobile services, GTM strategies, process and technology architectures according to one embodiment of the present invention. FIG. 3A is a flowchart 30 of the externally focused view showing a method of identifying new mobile services and measuring their effectiveness according to one embodiment of the present invention. FIG. 3B is a flowchart 35 showing one method of identifying internal return on investment based on suggested process and/or architecture roadmaps according to one embodiment of the present invention. FIG. 4 is a flowchart 40 of a process for implementing a mobile service in accordance with one embodiment of the present invention. Although specific steps are disclosed in flowcharts 10, 20, 30, 35 and 40, such steps are exemplary. That is, embodiments of the present invention are well suited to performing various other steps or variations of the steps recited in those flowcharts. It is appreciated that the steps in the flowcharts may be performed in an order different than presented, and that not all of the steps in the flowcharts may be performed.

FIG. 1 is described as a three-phase approach; however, embodiments of the present invention are not so limited. Also, although an action may be described as being in one phase, that action may instead be performed in a different phase. Moreover, although the present embodiment is described as a linear approach with distinct phases, with progress moving from one phase to the next, in effect the boundaries between phases may be somewhat blurred, and activities previously completed may be revisited after subsequent activities are performed. In general, each mobile service provider is treated individually, and the approach described can be customized depending on the particular requirements of a mobile service provider.

The purpose of Phase I, according to one embodiment, is to understand and help define the operator's business in the highly emerging mobile market. This typically presents itself as helping to identify and define mobile services not currently implemented by the mobile service provider. Updated techniques for new service development, and enhancements to current services, including, but not limited, to creating developer ecosystems, can be identified and proposed. A database, showing sample services, actual case studies, and business models, for example, can be accessed and utilized to introduce new mobile services to the mobile service provider. Other techniques, such as brainstorming, can also be used to identify services. Relevant case studies (e.g., straw man models) can be also be created. Examples based on case studies, showing improvements possible using the mobile services, can be produced. Real-time demonstrations of the services can be performed. Success stories associated with other mobile service providers can be presented.

Associated business and revenue models, perhaps based on the demographics of subscribers, can be furnished. These models can address, for example, the selling of services to subscribers; qualification and testing of services; pricing of services and testing of pricing; defining and managing the lifecycle of services; defining and assuring quality of service; defining rich media content to be collected and how to use and present that content; service qualification; and qualification of content providers.

Best practices associated with implementing new mobile services can be identified. Best practices may be associated with, for example, the mobile services themselves, technology, or with the business processes associated with those services. Then, for each new mobile service, the mobile service provider can be placed at a point in a continuum ranging from not implementing the mobile service to implementing the mobile service according to a respective best practice.

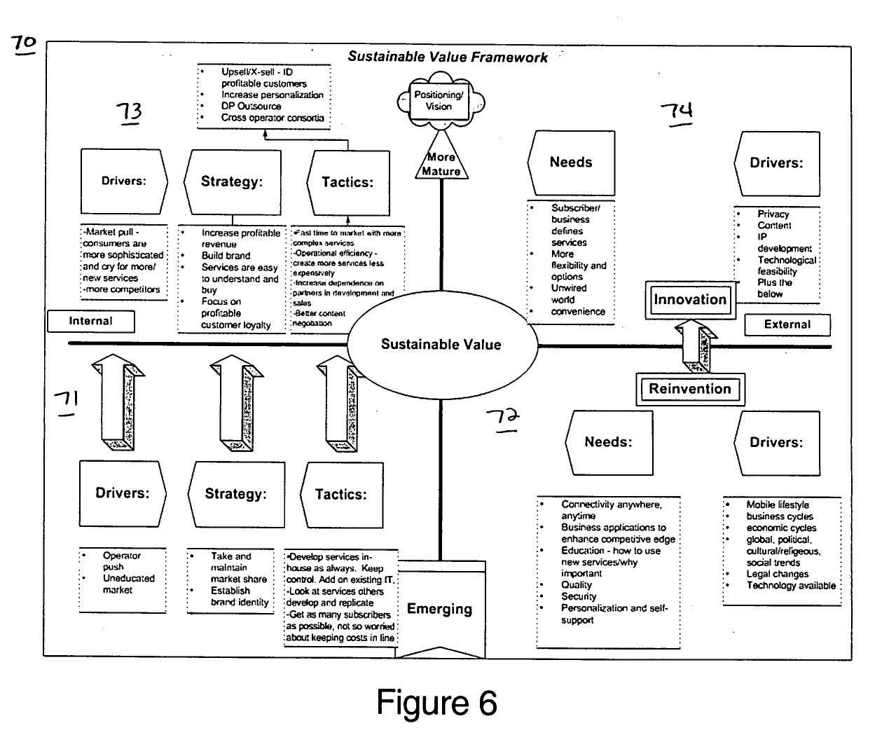

Phase II, according to one embodiment, addresses both the technology and process aspects of the mobile operator's business. This includes, but is not limited to, analyzing: the current state of the mobile service provider's architecture, technology roadmap(s), standards, resource skills, processes, data flows, process flows and data dictionary(ies). Factors driving the mobile service provider, both internally and externally, can be analyzed (see FIG. 6, for example). The provider's goals with respect to services, technologies, processes, data flows and the like can then be identified. The provider's current state can then be mapped to the goals to identify any gaps that may exist. A plan is then proposed to address any identified gaps.

Developer Ecosystems: One technique used to increase new service development, while decreasing operational costs, is to create a third-party developer “ecosystem.” An ecosystem shows the systemic relationships between the third party developer(s) and components of the operator's operational support system (OSS) and business support system (BSS) operations. The advantage to third-party developers is access to the mobile operator's subscriber base. Accordingly, this technique is presented conceptually in Phase I, and customized implementation for such an ecosystem is introduced in Phase II.

Existing third party relationships, management practices, and infrastructure can be utilized to provide a template approach to develop the ecosystem for the developers. The ecosystem can address issues such as, but not limited to, how to create a secure developer infrastructure on a provider's network; how to deploy a developer's “sandbox” (e.g., limitations on what resources can be requested or accessed); how to do UDDI (Universal Description, Discovery and Integration) replication; how to market services to developers, including developer outreach, education, and support; how to assure quality of service; how to support developers; and how to implement small or medium services either regionally or across the provider's entire network (perhaps internationally).

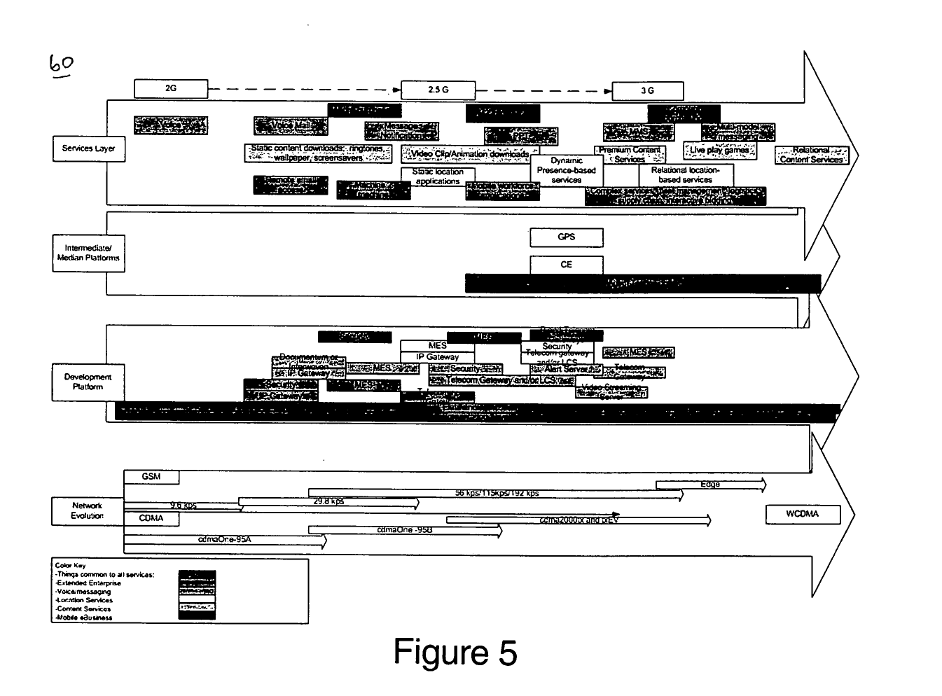

Considering the analysis just described, and also considering the work performed in Phase I, a baseline set of services that will fill any gaps between the provider's current state and the provider's desired state can be identified and planned for. Platforms for delivering those services can also be identified (see FIG. 5, for example). The services that have the promise of the highest return on investment can be prioritized accordingly. New or modified logical and physical architectures, and plans for implementing those architectures, can be created.

With reference still to FIG. 1, processes for implementing changes in service, and for managing those changes, can be created. Processes for test marketing services, and for using market information and other feedback to adjust the function or content of the service, can also be created. Mechanisms for gathering feedback from individual subscribers or across a market, channel or some other endpoint can also be created. In addition, processes needed to take the test platform/service to production can be created. Strategies for selling the services can be created. Also, processes for managing and measuring the lifecycles of services and content can be created. Processes for achieving the best quality of service, and for generating, measuring and monitoring service level agreements (SLAs), can also be created.

Phase II, according to one embodiment, occurs after new services and/or processes, and/or technology(ies) are deployed. Metrics can be defined, and expected values for those metrics (e.g., expected rates of return) can be set. Data and other information (e.g., subscriber feedback) that are indicators of the effectiveness of the new implementation/offering can be gathered and evaluated. Using this information, actual values for the metrics are determined and compared against expected values. If the expected values are not being achieved, then the implementation/offering can be reviewed and adjusted as necessary.

FIG. 2 is a flowchart 20 showing one instance of a method for identifying new mobile services according to one embodiment of the present invention. This method can also apply to: service roadmaps, GTM strategies, and process and technology roadmaps.

In step 22, an environmental context associated with the mobile service provider is defined. The environmental context may include factors that drive the mobile service provider (e.g., see FIG. 6), and may also include the relationships between the mobile service provider and third-party developers of mobile services.

In step 24 of FIG. 2, one or more case studies relevant to the mobile service provider are evaluated.

In step 26, gap(s) between the current state of the mobile service provider and a desired state of the mobile service provider are identified.

In step 28, strategies are designed to address the identified gaps. A matrix of mobile services versus technologies associated with the mobile services can be used as an aid in identifying the mobile service(s) (e.g., see FIG. 5). The mobile service(s) can be prioritized relative to each other. An architecture for implementing the mobile service(s) can be identified. Process(es) for managing implementation of the mobile service can also be defined.

FIG. 3A is a flowchart 30 which is an instance of an external view showing a method of identifying new mobile services and measuring their effectiveness according to one embodiment of the present invention.

In step 31, a mobile service provider identifies a business goal. A mobile service intended to achieve that goal is identified, as described above.

In step 32, a metric for measuring an effect of implementing the mobile service is established.

In step 33, after the mobile service provider implements the mobile service, input information (e.g., customer feedback, actual rates of return, etc.) that measures the effect of implementing the mobile service is compared against an expected value of the metric.

In step 34, any services or changes can be reviewed and adjusted if the comparison indicates the expected value is not satisfied.

FIG. 3B is a flowchart 35 showing one method of identifying internal return on investment based on suggested process and/or architecture roadmaps according to one embodiment of the present invention. This internal instance measures such things as changes to process and/or IT infrastructure.

In step 36, changes to existing processes and IT infrastructure to support a proposed service or business roadmap are identified.

In step 37, a metric for measuring the effect of changes to the existing operational processes and IT infrastructure is created.

In step 38, input information that measures the effect of implementing the changes is compared against an expected value of the metric.

In step 39, any services or changes can be reviewed and adjusted if the comparison indicates the expected value is not satisfied.

FIG. 4 is a flowchart 40 showing a best practice process for implementing a mobile service in accordance with one embodiment of the present invention.

In block 41, an overall service roadmap is created with the mobile service provider. Using the methods described above, new services are identified. Services can be prioritized, and GTM strategies customized. A go/no go decision can be made at this point.

In block 42, new services can be conceived and/or described in detail within the context and confines of the roadmap of block 41. A go/no go decision can then be made.

In block 43, a business case showing an assessment of the impact of the new services on the provider's business can be made. Again, a go/no go decision can then be made.

In block 44, contracts with partners, content collection, and the service architecture are finalized and, in block 45, tested. Another go/no go decision can then be made.

In block 46, testing of the new services can be performed, followed by a go/no go decision.

In block 47, a limited launch of the new services is conducted, followed by another go/no go decision.

In block 48, a full launch of the new services is performed. The lifecycle of the services can then be reviewed (block 49), and a go/no go decision is then made.

In block 50, the service is continued as-is. Alternatively, the service is adjusted to renew interest in the marketplace, and flowchart 40 returns to block 44. Otherwise, in block 51, the service is terminated.

FIG. 5 illustrates one example of a service and technology matrix 60 that can be used to identify mobile services according to one embodiment of the present invention. Matrix 60 shows the progression from second generation to third generation mobile services and technologies along the horizontal axis, as well as the various service layers, intermediate/median platforms, development platforms, and networks needed to support these services. The various elements are aligned in the vertical direction so that, for a particular mobile service, associated intermediate/median platforms, development platforms, and networks can be identified. Matrix 60 thus provides a ready means for a mobile service provider to determine, for a desired mobile service, the technologies that the provider needs to have in place or have access to in order to provide that service.

FIG. 6 illustrates an example of an environmental framework 70 for identifying drivers, strategies, tactics and needs that can influence a mobile service provider in accordance with one embodiment of the present invention. Framework 70 can be divided into quadrants 71, 72, 73 and 74. Quadrants 71 and 73 describe examples of drivers, strategies and tactics that are internal to the mobile service provider, while quadrants 72 and 74 describe examples of drivers and needs that are external to the mobile service provider. As a provider's business becomes more mature, the provider will move from quadrants 71 and 72 into quadrants 73 and 74. In doing so, the provider becomes more likely to turn to third-party developers as the source for new mobile services.

In summary, embodiments in accordance with the present invention provide methods for analyzing the mobile services market; researching technology implications; building service solutions; integrating the services into the existing infrastructure of a mobile service provider or identifying additional infrastructure needed for the services; and then testing, validating and launching the services. Instead of an ad hoc approach, embodiments in accordance with the present invention provide a systematic approach that covers the full spectrum from identification of a mobile service provider's goals; identification of new services that can be implemented to achieve those goals; GTM aspects; process improvements needed to take advantage of new technologies; management of change needed to implement new processes; measurement of the effect of the new services; and finally adjustment of those services, if need be, to achieve the service provider's goals. In addition, embodiments in accordance with the present invention consider both the marketing and the technical aspects of introducing new services.

As a result of the methods described herein, time to market can be reduced, and providers can adjust quickly to changing patterns of usage and changing delivery platforms. Providers can discover new revenue sources and potential business, and gain perspective on emerging markets. In general, providers gain understanding of the scope of their markets and the implications for their businesses, and are able to identify and prioritize services and architectures that deliver real benefits.

Embodiments of the present invention are thus described. While the present invention has been described in particular embodiments, it should be appreciated that the present invention should not be construed as limited by such embodiments, but rather construed according to the following claims.

1. A method of identifying and measuring the effectiveness of mobile services and their GTM (go-to-market), process and technology links, said method comprising:
defining a change in mobile service and associated process and technology links to achieve an end-goal of a mobile service provider;
subsequent to said mobile service provider implementing said change, comparing input information measuring said effect against an expected value of a metric for measuring an effect of implementing said change; and
reviewing said change and said mobile service if said comparing indicates said expected value is not satisfied.

2. The method of claim 1 further comprising:
developing unique GTM aspects for said mobile service.

3. The method of claim 1 further comprising:
updating operational processes and technology roadmaps associated with said change.

4. The method of claim 1 wherein said defining comprises:
identifying a gap between a current state of said mobile service provider and said end-goal; and
identifying a change in mobile service and associated processes and technologies that address said gap.

5. The method of claim 4 further comprising:
evaluating a case study relevant to said mobile service provider and said change.

6. The method of claim 1 further comprising:
prioritizing said change in mobile service relative to other changes undergoing consideration.

7. The method of claim 1 further comprising:
identifying an architecture for implementing said mobile service along with other mobile services.

8. The method of claim 1 further comprising:
defining an environmental context associated with said mobile service provider, said environmental context comprising factors driving said mobile service provider and also comprising relationships between said mobile service provider and third-party developers of mobile services.

9. The method of claim 1 further comprising:
using a matrix of mobile services versus technologies associated with said mobile services to identify said change in mobile service and associated processes and technologies.

10. The method of claim 1 further comprising:
adjusting said change in mobile service if said comparing indicates said expected value is not satisfied; and
comparing said input information quantifying said effect against said metric subsequent to said adjusting, wherein further adjustments to said mobile service can be made in order to satisfy said metric.

11. The method of claim 1 further comprising:
defining and updating processes used in the implementation of said mobile service.

12. A method of improving a mobile service provider, said method comprising:
defining an environmental context associated with said mobile service provider, said environmental context comprising factors driving said mobile service provider and also comprising relationships between said mobile service provider and a third-party developer of mobile services;
evaluating a case study relevant to said mobile service provider;
identifying a gap between a current state of said mobile service provider and a desired state defined for said mobile service provider; and
identifying a mobile service and associated processes and technologies that address said gap.

13. The method of claim 12 further comprising:
establishing a metric for measuring an effect of implementing a change in mobile service;
subsequent to said mobile service provider implementing said change, comparing input information measuring said effect against an expected value of said metric; and
adjusting said change if said comparing indicates said expected value is not satisfied.

14. The method of claim 12 further comprising:
prioritizing said mobile service and associated process changes and technology updates relative to other mobile services under consideration.

15. The method of claim 12 further comprising:
identifying an architecture for implementing said mobile service along with other mobile services.

16. The method of claim 12 further comprising:
using a matrix of mobile services versus technologies associated with said mobile services to identify said mobile service and associated technologies.

17. The method of claim 12 further comprising:
defining a process for managing implementation of said mobile service.

18. A method for identifying mobile service improvements, said method comprising:
identifying a plurality of mobile services not currently implemented by said mobile service provider;
providing examples showing improvements possible using said mobile services;
identifying best practices associated with implementing said mobile services; and
for each mobile service, placing said mobile service provider at a point in a continuum ranging from not implementing said mobile service to implementing said mobile service according to a respective best practice.

19. The method of claim 18 further comprising:
creating a plan to mitigate risk and fill identified gaps for each continuum instance.

20. The method of claim 18 further comprising:
selecting an update to a mobile service and to internal processes and technologies associated with said mobile service;
establishing a metric for measuring an effect of implementing said update;
subsequent to said mobile service provider implementing said update, comparing input information measuring said effect against an expected value of said metric; and
adjusting said update if said comparing indicates said expected value is not satisfied.

21. The method of claim 20 further comprising:
defining a process for managing implementation of said mobile service.

22. The method of claim 18 wherein said providing examples further comprises:
evaluating case studies relevant to said mobile services.

23. The method of claim 18 further comprising:
defining an environmental context associated with said mobile service provider, said environmental context comprising factors driving said mobile service provider and also comprising relationships between said mobile service provider and other parties involved in a mobile service creation value chain.

24. The method of claim 18 further comprising:
using a matrix of mobile services versus technologies associated with said mobile services to support said mobile service provider's identified business and services roadmaps.
